(19) United States
(12) Patent Application Publication
(10) Pub. No.: US 2016/0311353 A1
(43) Pub. Date: Oct. 27, 2016

(54) CLIP

(71) Applicants: TOYOTA BOSHOKU KABUSHIKI KAISHA, Kariya-shi (Aichi) (JP); NIFCO INC., Yokosuka-shi (Kanagawa) (JP)

(72) Inventors: Takahiro YASUDA, Kariya-shi (Aichi) (JP); Sohei MIURA, Yokosuka-shi (Kanagawa) (JP)

(21) Appl. No.: 15/134,536

(22) Filed: Apr. 21, 2016

(30) Foreign Application Priority Data
Apr. 22, 2015 (JP) 2015-087833

(51) Int. Cl. B60N 2/60

(52) U.S. Cl. CPC B60N 2/6018; B60N 2/6027

(57) ABSTRACT

A clip has: a clip main body; a holding portion that is provided at the clip main body, and that has a caught-on portion on which a protruding portion, that protrudes-out from an outer periphery of a linear member, a fastening rubber as an example, is caught, and the holding portion holds the protruding portion that is caught on the caught-on portion; an insert portion that is provided at the clip main body, and that is inserted into an insert hole formed in a mounted-to member, a lower panel as an example; and an anchor portion, a hook portion as an example, that is provided at the clip main body, and that is caught on an upper end portion of the lower panel from a same direction as a direction in which the protruding portion is caught on the caught-on portion.

### CROSS-REFERENCE TO RELATED APPLICATION

This application claims priority under 35 USC 119 from Japanese Patent Application No. 2015-087833 filed Apr. 22, 2015, the disclosure of which is incorporated by reference herein.

### BACKGROUND

1. Field of the Invention

The present invention relates to a clip, and, in particular, to a clip for a linear member.

2. Related Art

Japanese Patent Application Laid-Open (JP-A) No. 2011-126376 discloses a clip for fixing a fastening rubber, that is shaped as a string and is for mounting a seatback cover to a seatback main body of a vehicle seat, to the lower panel of the seatback main body. This clip has a holding portion that holds a projecting portion of the fastening rubber that is in a stretched state, and an anchor portion that is anchored on a mounting hole provided in the lower panel.

Restoring force (return force) of the fastening rubber is always applied to the clip disclosed in JP-A No. 2011-126376. Therefore, a countermeasure for making it difficult for the clip to come-off of the lower panel with respect to the restoring force of the fastening rubber, is required of the clip for fixing the fastening rubber to the lower panel.

### SUMMARY

In view of the above-described circumstances, the present invention provides a clip that is easily mounted to a mounted-to member, and that is difficult to come-off for force received from a linear member.

A clip of a first aspect includes: a clip main body; a holding portion that is provided at the clip main body, and that has a caught-on portion on which a protruding portion, that protrudes-out from an outer periphery of a linear member, is caught, and that holds the protruding portion that is caught on the caught-on portion; an insert portion that is provided at the clip main body, and that is inserted into an insert hole formed in a mounted-to member; and an anchor portion that is provided at the clip main body, and that is caught on an anchored-on portion, formed at the mounted-to member, in a same direction as a catch direction in which the protruding portion is caught on the caught-on portion.

In the clip of the first aspect, the clip main body is mounted to a mounted-to member, by the anchor portion being caught on the anchored-on portion of the mounted-to member, the clip main body being rotated around the anchor portion as fulcrum, and the insert portion being inserted in the insert hole of the mounted-to member. Namely, this clip can easily be mounted to the mounted-to member. At the clip, the protruding portion of the linear member is held at the holding portion due to the protruding portion being caught on the caught-on portion of the holding portion. Due thereto, the linear member is fixed to the mounted-to member via the clip.

Further, at this clip, the anchor portion is caught on the anchored-on portion of the mounted-to member, in the same direction as the direction in which the protruding portion of the linear member is caught on the caught-on portion. Therefore, in a case in which force in the catch direction is applied to the linear member, it is difficult for the anchor portion to come-off of the anchored-on portion for force received from the protruding portion via the caught-on portion.

In a clip of a second aspect, in the clip of the first aspect, the mounted-to member is a panel member, the anchored-on portion is an end portion of the panel member, and the anchor portion is a hook portion having a shape that covers the end portion of the panel member from an obverse side to a reverse side.

In the clip of the second aspect, the anchor portion is a hook portion that is a shape that covers the end portion of the panel member from the obverse side to the reverse side. Therefore, it is easy for the hook portion to be caught on the end portion of the panel member. Further, at this clip, it is difficult for the hook portion to come-off of the end portion of the panel member for force that is received from the protruding portion of the linear member via the caught-on portion.

In a clip of a third aspect, the clip of the second aspect further includes a claw portion that is elastically deformable, and that projects-out from an outer periphery of the insert portion, the claw portion being inserted in the insert hole together with the insert portion in an elastically deformed state, and being caught on an edge portion of the insert hole by being restored from the deformed state.

In the clip of the third aspect, the claw portion is, in an elastically deformed state, inserted into the insert hole together with the insert portion. When the claw portion that has been inserted is restored, the claw portion is caught on the edge portion of the insert hole. Therefore, the insert portion coming-out of the insert hole is suppressed.

In a clip of a fourth aspect, in the clip of the third aspect, the insert portion is disposed further toward a side of the catch direction than the hook portion.

In the clip of the fourth aspect, the insert portion is disposed further toward the side in the catch direction (the direction in which the protruding portion of the linear member is caught on the caught-on portion) than the hook portion. Therefore, it is easy for the hook portion to be caught on the end portion of the panel member, as compared with a case in which, for example, the insert portion is disposed further toward the side opposite the catch direction than the hook portion.

In a clip of a fifth aspect, in the clip of the fourth aspect, the claw portion is elastically deformable toward the side of the catch direction.

In the clip of the fifth aspect, the claw portion is, in a state of being elastically deformed toward the side in the catch direction (the direction in which the protruding portion of the linear member is caught on the caught-on portion), inserted into the insert hole together with the insert portion. When the claw portion that has been inserted is restored, the claw portion is caught on the edge portion, that is at the side opposite the catch direction, of the insert hole. Therefore, at this clip, floating-up, from the panel member, of the clip main body around the hook portion or the insert portion as fulcrum is suppressed as compared with a structure in which, for example, the claw portion is made to be elastically deformable toward the side opposite the catch direction.

In a clip of a sixth aspect, in the clip of any of the first through fifth aspects, the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and the holding portion has a wall portion that is provided at the plate-shaped portion and restricts movement, in a direction orthogonal to the catching direction, of the protruding portion that is caught on the opening edge portion of the cut-out portion.

In the clip of the sixth aspect, in the state in which the protruding portion is caught on the opening edge portion of the cut-out portion, movement of the protruding portion in the direction orthogonal to the catch direction (the direction in which the protruding portion of the linear member is caught on the caught-on portion) is restricted by the wall portion. Therefore, at this clip, the protruding portion coming-off of the caught-on portion is suppressed as compared with a structure that, for example, does not have the wall portion. Namely, it is difficult for the linear member to come-out of the clip.

In a clip of a seventh aspect, in the clip of any of the first through sixth aspects, the clip further includes a concave portion that is formed in the clip main body such that a part of the protruding portion is accommodated in the concave portion in a state in which the protruding portion is caught on the caught-on portion.

In a clip of an eighth aspect, in the clip of any of the first through seventh aspects, the clip further includes a linear member holding portion that is formed at an outer side portion of the holding portion, and that holds the linear member.

In accordance with the present invention, there can be provided a clip that is easily mounted to a mounted-to member, and that is difficult to come-off for force received from a linear member.

### BRIEF DESCRIPTION OF THE DRAWINGS

Exemplary embodiments will be described in detail with reference to the following figures, wherein:

FIG. 1 is a schematic drawing of a vehicle seat that uses a clip relating to a first exemplary embodiment;

FIG. 2 is a front view in which the clip of FIG. 1 is seen from the back surface side of the vehicle seat;

FIG. 3 is an exploded perspective view in which a lower panel of the vehicle seat of FIG. 1, the clip, and a linear member are taken apart;

FIG. 4 is a perspective view of the clip of FIG. 3;

FIG. 5 is a front view of the clip of FIG. 4;

FIG. 6 is a top view in which the clip of FIG. 4 is seen from the arrow 6 direction;

FIG. 7 is a side view in which the clip of FIG. 4 is seen from the arrow 7 direction, and a portion of which is made to be a broken cross-section;

FIG. 8 is a perspective view of a clip relating to a second exemplary embodiment;

FIG. 9 is a front view of the clip of FIG. 8;

FIG. 10 is a side view in which the clip of FIG. 8 is seen from the arrow 10 direction, and a portion of which is made to be a broken cross-section;

FIG. 11 is a front view of a clip relating to a third exemplary embodiment;

FIG. 12A is a cross-sectional view, along arrow 12-12, of the clip of FIG. 11;

FIG. 12B is an enlarged view of the portion indicated by arrow 12B in FIG. 12A;

FIG. 13A is a cross-sectional view of a modified example of the clip relating to the third embodiment of the present invention (a cross-sectional view corresponding to FIG. 12A); and

FIG. 13B is an enlarged view of the portion indicated by arrow 13B in FIG. 13A.

### DETAILED DESCRIPTION

### First Exemplary Embodiment

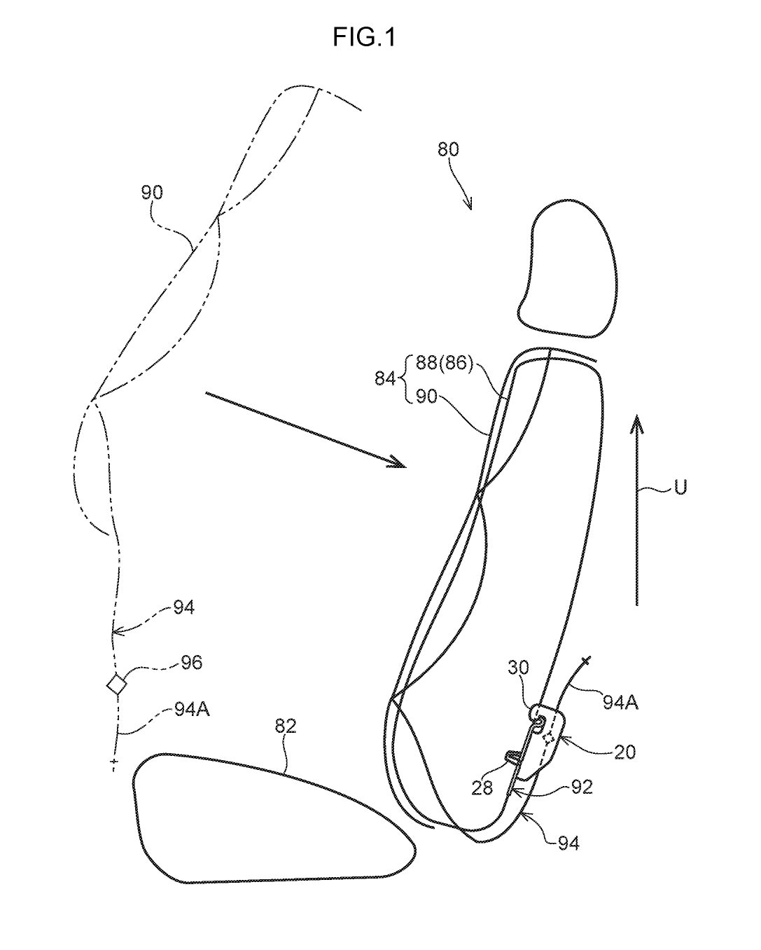

A clip 20 relating to a first exemplary embodiment is described by using FIG. 1 through FIG. 7. The clip 20 of the present embodiment is used for fixing a fastening rubber 94, that is for attaching a seatback cover 90 to a seatback main body 86 of a vehicle seat 80 (hereinafter simply called “seat 80”), to a lower panel 92 of the seatback main body 86.

In some of the drawings, the upward direction of the seat is indicated by arrow U, and the transverse direction (the width direction) of the seat is indicated by arrow W.

The seat 80 is described first.

As shown in FIG. 1, the seat 80 has a seat cushion 82 on which a person sits, and a seatback 84 that is reclinably supported at the seat cushion 82.

The seatback 84 has the seatback main body 86, at which a cushion material member 88 that forms the outer shape of the seatback 84 is assembled to a seatback frame (not shown in the drawings) that forms the frame of the seatback 84, and the seatback cover 90 that is mounted to the seatback main body 86 and covers the cushion material member 88.

A lower panel 92 that structures the seatback frame is disposed at the lower portion of the back (rear) surface of the seatback main body 86. Concretely, the lower panel 92 is formed so as to span between the both side frames of the seatback frame. Note that the lower panel 92 of the present embodiment is an example of a panel member that is included in the mounted-to member of the present invention.

The seatback cover 90 is attached to the seatback main body 86, due to the fastening rubber 94, that is mounted at the back (rear) surface portion of the seatback cover 90, being held, in a state in which tension is applied thereto, by a clip 20 that is mounted to the lower panel 92.

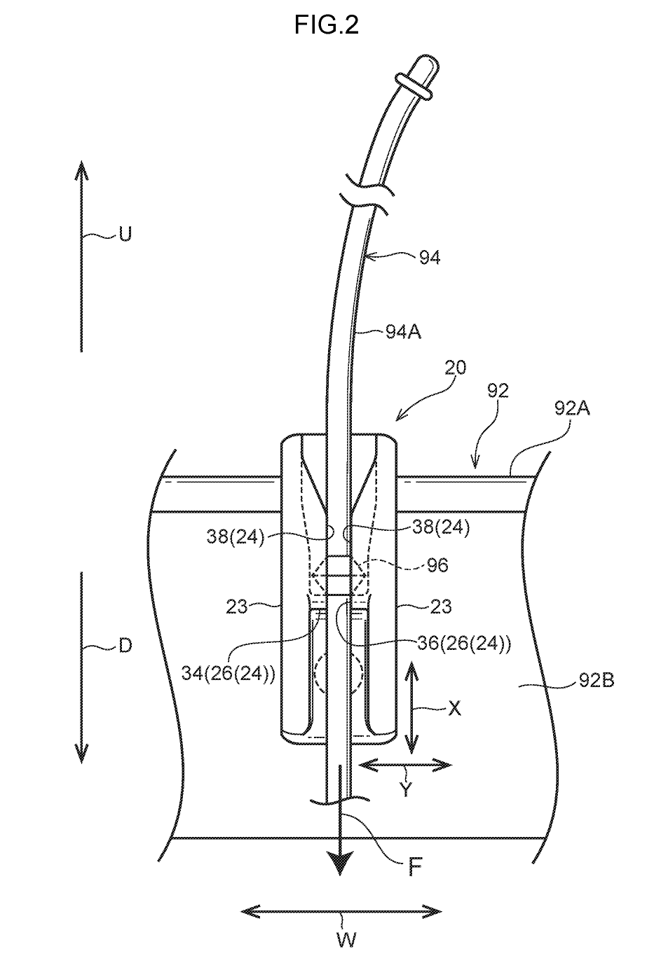

As shown in FIG. 2, the clip 20 is mounted to the lower panel 92. Concretely, a hook portion 30, that is described later, of the clip 20 is caught on an upper end portion 92A of the lower panel 92, and an insert portion 28, that is described later, of the clip 20 is inserted into an insertion hole 93 that is formed in the lower panel 92, and the clip 20 is mounted to the lower panel 92. Note that the upper end portion 92A of the lower panel 92 is an example of the end portion of the panel member that is included in the anchored-on portion of the present invention.

The fastening rubber 94 is described next.

As shown in FIG. 1 and FIG. 2, the fastening rubber 94 is formed by a rubber material being formed into a linear shape, and can stretch in the length direction thereof. Note that the fastening rubber 94 of the present embodiment is an example of the linear member of the present invention.

A ring portion, that is not shown in the drawings and that is caught on the seatback cover 90 is formed at a length direction one end portion of the fastening rubber 94. Further, a protruding portion (overhang portion) 96, that is annular shape and protrudes-out from the outer periphery of the fastening rubber 94, is provided at the length direction another end portion side (the side that is held by the clip 20) of the fastening rubber 94. This protruding portion 96 is provided so as to be apart from the length direction another end portion of the fastening rubber 94 by a predetermined length (a length that is such that the fastening rubber 94 can be grasped by a worker at the time when the worker pulls the fastening rubber 94). Note that, hereinafter, the portion of the fastening rubber 94 from the protruding portion 96 to the length direction another end portion is called a surplus length portion 94A.

The clip 20 of the present embodiment is described next. As shown in FIG. 2 through FIG. 5, the clip 20 is an elongated member that is formed of resin. In the following description, the length direction of the clip 20 is appropriately abbreviated as the clip length direction, the transverse (width) direction of the clip 20 is appropriately abbreviated as the clip transverse (width) direction, and the thickness direction of the clip 20 (in other words, the depthwise direction) is appropriately abbreviated as the clip thickness direction. Further, in some of the drawings, the clip length direction is denoted by arrow X, the clip transverse direction is denoted by arrow Y, and the clip thickness direction is denoted by arrow Z.

The clip 20 has a clip main body 22, a holding portion 24 that has a caught-on portion 26 on which the protruding portion 96 of the fastening rubber 94 is caught, and that holds the protruding portion 96 that is caught on the caught-on portion 26, the insert portion 28 that is inserted into the insertion hole 93 of the lower panel 92, and the hook portion 30 that is caught on the upper end portion 92A of the lower panel 92 from the same direction as the direction in which the protruding portion 96 is caught on the caught-on portion 26. The hook portion 30 is provided at the length direction one end side of the clip 20, and the insert portion 28 is provided at the length direction another end side of the clip 20. Further, in the state in which the clip 20 is mounted to the lower panel 92, the length direction one end side of the clip 20 is toward the upper side of the seat, and the length direction another end side of the clip 20 is toward the lower side of the seat.

Further, although described in detail later, the “direction in which the protruding portion 96 of the fastening rubber 94 is caught on the caught-on portion 26” is the seat downward direction (hereinafter appropriately called “arrow D direction”) in the state in which the clip 20 is mounted to the lower panel 92.

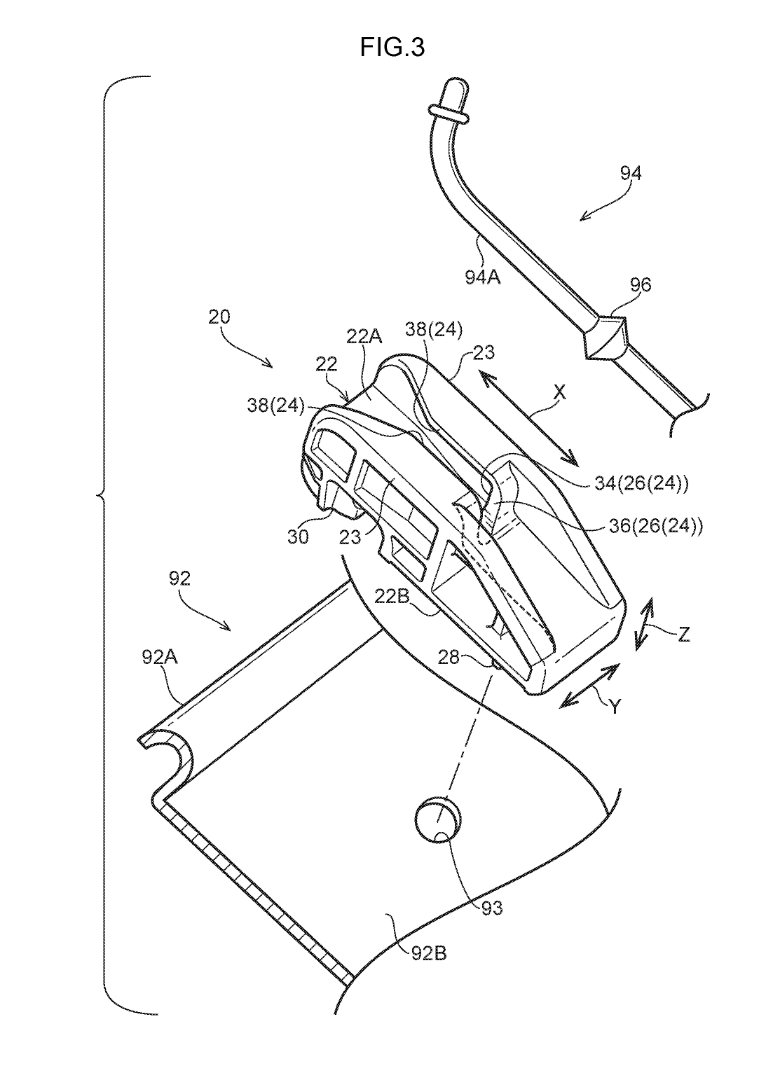

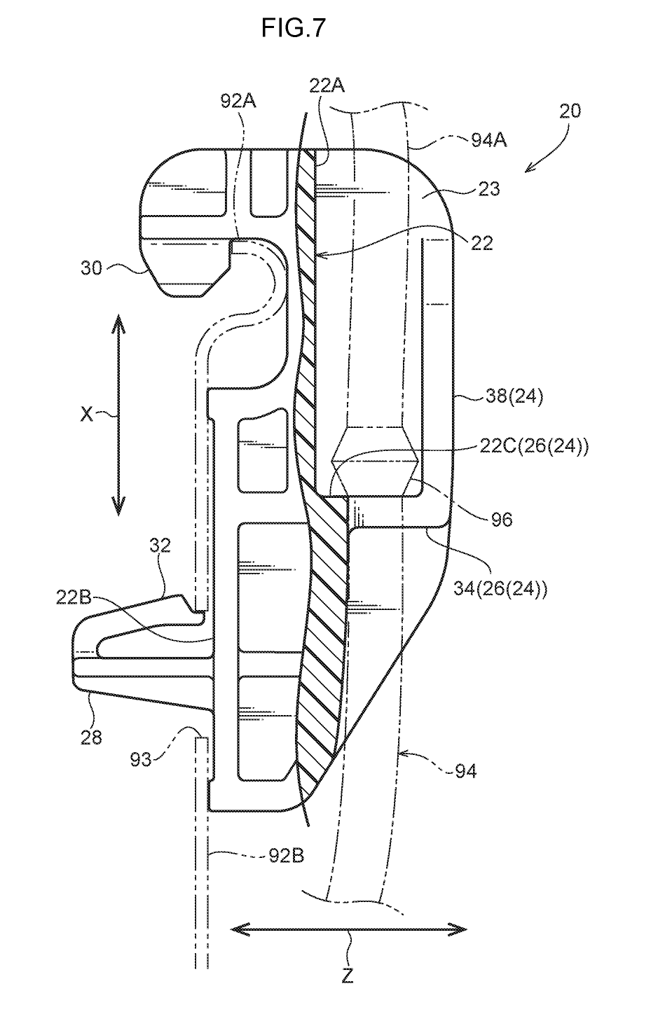

As shown in FIG. 3 and FIG. 7, the clip main body 22 is the portion that is the base of the clip 20. In the state in which the clip 20 is mounted to the lower panel 92, a reverse (back face) 22B of the clip main body 22 faces an obverse (front face) 92B of the lower panel 92. Side wall portions 23 and the holding portion 24 are respectively provided at an obverse 22A of the clip main body 22 (the surface at a clip thickness direction one side, or, in other words, the surface at the side opposite the lower panel 92). Further, the insert portion 28 and the hook portion 30 are respectively provided at the reverse 22B of the clip main body 22 (the surface at a clip thickness direction another side, or, in other words, the surface at the lower panel 92 side).

Further, at the obverse 22A of the clip main body 22, the portion thereof that is further toward the insert portion 28 side than the hook portion 30 side protrudes-out toward the clip thickness direction one side, and a step portion 22C is provided between the insert portion 28 and the hook portion 30 in the clip length direction.

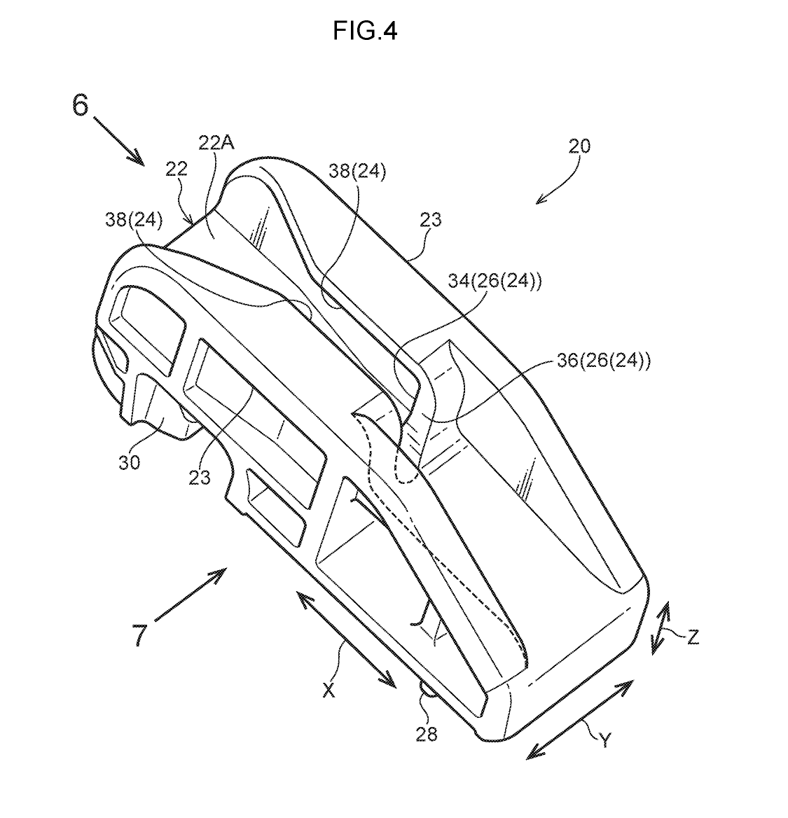

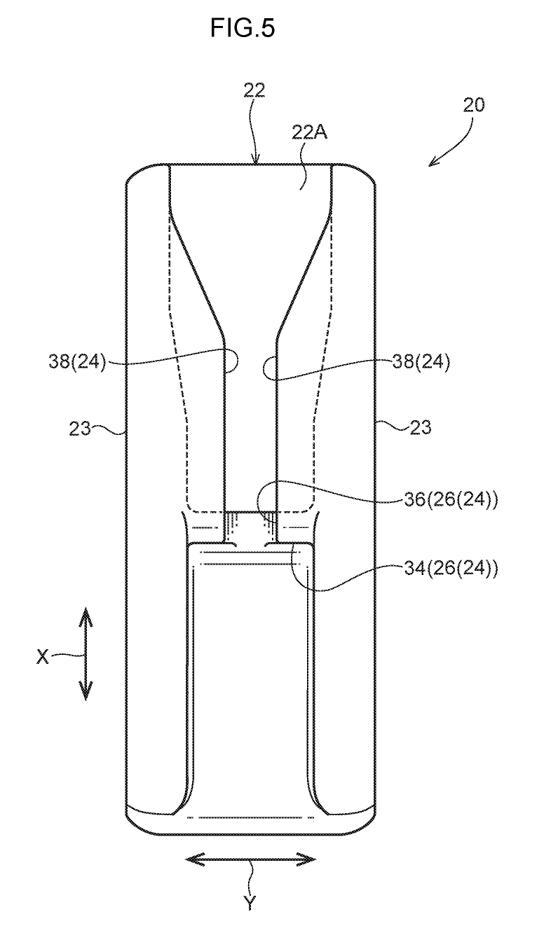

As shown in FIG. 4 and FIG. 5, the side wall portions 23 stand erect toward the clip thickness direction one side from the clip transverse direction both end portions of the clip main body 22 respectively, and are formed continuously from one end to the another end in the clip length direction of the clip main body 22. The holding portion 24 is disposed between these side wall portions 23.

As shown in FIG. 2 and FIG. 3, the holding portion 24 has the caught-on portion 26, and wall portions 38 that restrict movement of the protruding portion 96, that is caught on the caught-on portion 26, in the direction orthogonal to the catching direction (the arrow D direction).

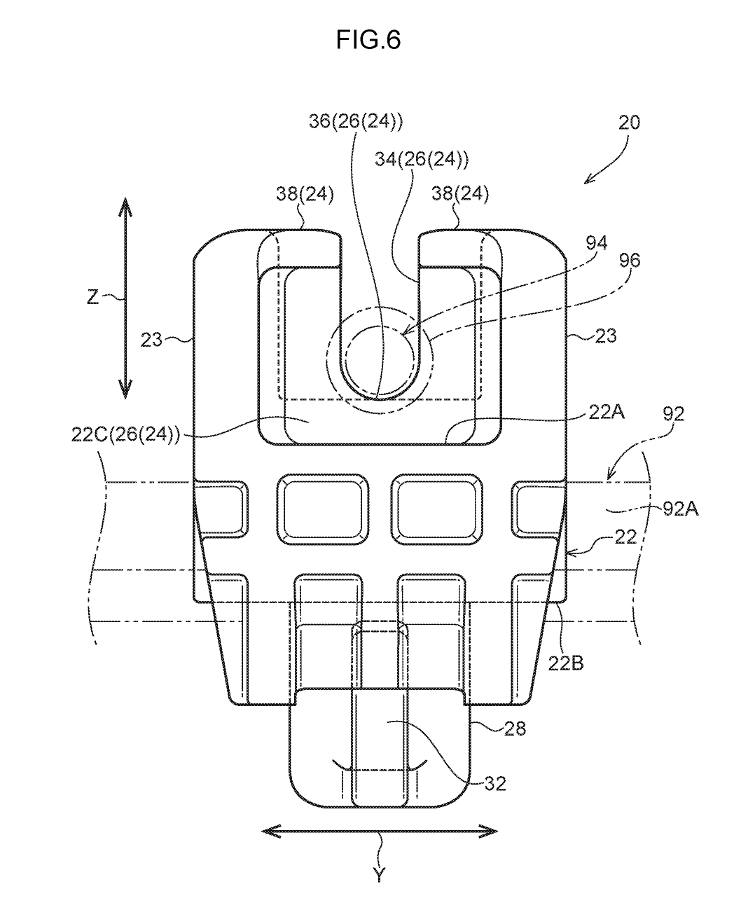

As shown in FIG. 2 and FIG. 6, the caught-on portion 26 is structured to include a plate-shaped portion 34, and a cut-out portion 36 that is formed at the plate-shaped portion 34, through which the fastening rubber 94 is inserted and at which the protruding portion 96 is caught on the opening edge portion that is at the side opposite the arrow D direction (in other words, that is at the clip length direction one side). Note that, in the present embodiment, because the protruding portion 96 is caught on the step portion 22C as well, the step portion 22C is also included in the caught-on portion 26.

The plate-shaped portion 34 is a portion that is plate-shaped and that projects-out toward the clip thickness direction one side from the obverse 22A of the clip main body 22. Both end portions, in the clip 20 transverse direction, of the plate-shaped portion 34 are connected to the side wall portions 23, respectively. Further, the plate-shaped portion 34 is disposed between the insert portion 28 and the hook portion 30, in the clip length direction of the clip main body 22. Concretely, the plate-shaped portion 34 is disposed at a portion that corresponds to the step portion 22C of the clip main body 22.

As shown in FIG. 6, the cut-out portion 36 is a notch or cut-out that is cut-out in the shape of a groove from the end portion in the projecting direction of the plate-shaped portion 34 (i.e., the end portion at one side in the clip thickness direction) toward the clip main body 22. The width of this cut-out portion 36 is made to be a width that is such that the fastening rubber 94 can be inserted therethrough and the protruding portion 96 is caught thereon. Further, the aforementioned wall portions 38 are respectively provided at the both sides of the cut-out portion 36 of the plate-shaped portion 34, sandwiching an entrance portion of the cut-out portion 36.

The wall portions 38 protrude toward the clip length direction one side from the end portion in the protruding direction of the plate-shaped portion 34. The end portions, in the clip transverse direction, of these wall portions 38 are connected to the side wall portions 23 respectively.

As shown in FIG. 7, the hook portion 30 is made into a shape that covers the upper end portion 92A of the lower panel 92 from the obverse side to the reverse side. This hook portion 30 is made into the shape of a hook that opens toward the clip length direction another side (i.e., the arrow D direction side). Therefore, the hook portion 30 is caught on the upper end portion 92A of the lower panel 92 from the same direction as the direction in which the protruding portion 96 of the fastening rubber 94 is caught on the caught-on portion 26.

The insert portion 28 is disposed further toward the clip length direction another side (the arrow D direction side) than the hook portion 30. The insert portion 28 has, at the outer periphery thereof, a claw portion 32 that is elastically deformable.

The claw portion 32 projects-out from the outer periphery of the insert portion 28 toward the clip length direction one side (the side opposite the arrow D direction), and can elastically deform toward the clip length direction another side (the arrow D direction side). After the claw portion 32 is, in a state of being elastically deformed, inserted together with the insert portion 28 into the insert hole 93, the claw portion 32 is restored, and thereby is caught on the edge portion, at the seat upper side (the side opposite the arrow D direction), of the insert hole 93.

Note that, in the present embodiment, the clip 20 is made to be an integrally molded resin piece (single piece), but the present invention is not limited to this structure. For example, the clip 20 may be structured such that some regions thereof are mounted afterwards.

An example of the attachment processes for attaching the seatback cover 90 to the seatback main body 86 by using the clip 20 is described next.

First, the clip 20 is mounted to the lower panel 92. Concretely, the hook portion 30 of the clip 20 is made to catch on the upper end portion 92A of the lower panel 92, and the clip main body 22 is rotated around the hook portion 30 as fulcrum, and the insert portion 28 is inserted into the insert hole 93 of the lower panel 92. At this time, the claw portion 32 is, in a state of being elastically deformed, inserted into the insert hole 93 together with the insert portion 28. The claw portion 32 that has been inserted is restored and is caught on the edge portion at the seat upper side (the side opposite the arrow D direction) of the insert hole 93, and the clip 20 is mounted to the lower panel 92.

Next, the seatback cover 90 is set at the seatback main body 86. Concretely, as shown in FIG. 1, the fastening rubber 94, whose ring portion that is not shown in the drawings is caught on the back surface portion of the seatback cover 90, is embedded in a mounting groove that is not shown in the drawings and that is provided in the seatback main body 86, and the another end portion of the fastening rubber 94 (the end portion at the side at which the protruding portion 96 is provided) is passed-through the seat lower side of the seatback main body 86 and pulled-out to the back surface side. Due thereto, the seatback cover 90 is set at the seatback main body 86.

Next, the clip 20 is made to hold the fastening rubber 94, and the seatback cover 90 is attached to the seatback main body 86. Concretely, as shown in FIG. 1 and FIG. 2, while the another end portion of the fastening rubber 94, that is passed around the seat lower side of the seatback main body 86 and pulled-out, is pulled toward the seat upper side, the protruding portion 96 is raised-up further toward the seat upper side than the holding portion 24 of the clip 20, and the fastening rubber 94 is stretched (pulled). In this stretched (pulled) state, the fastening rubber 94 is pulled, and the seatback cover 90 is made to fit closely to the seatback main body 86. Then, the fastening rubber 94 is inserted-through the cut-out portion 36 of the holding portion 24 of the clip 20, and the protruding portion 96 is made to catch on the opening edge portion that is at the clip length direction one side (the side opposite the arrow D direction) of the cut-out portion 36. Due thereto, the fastening rubber 94 is held by the clip 20 (see FIG. 1 and FIG. 2). At this time, as shown in FIG. 2, in the fastening rubber 94, restoring force (tensile stress) F so as to restore from this stretched state arises in the arrow D direction, so, the seatback cover 90 is attached to the seatback main body 86.

Note that the attachment processes for attaching the seatback cover 90 to the seatback main body 86 by using the clip 20 are not limited to the above-described order, and the order of the attachment processes may be changed. For example, the seatback cover 90 may be attached to the seatback main body 86 by attachment processes in which, in the state in which the fastener rubber 94 is held by the clip 20, the fastener rubber 94 is stretched, and the clip 20 is mounted to the lower panel 92.

Operation and effects of the clip 20 of the present embodiment are described next. As described above, at the clip 20, the hook portion 30 is made to be caught on the upper end portion 92A of the lower panel 92, and the clip main body 22 is pivoted around the hook portion 30 as fulcrum, and the insert portion 28 is inserted into the insert hole 93 of the lower panel 92. The clip main body 22 is thereby mounted to the lower panel 92. Namely, the clip 20 can be easily mounted to the lower panel 92.

Further, at the clip 20, the protruding portion 96 of the fastening rubber 94 is held at the holding portion 24 due to the protruding portion 96 being caught on the caught-on portion 26 of the holding portion 24. Due thereto, the fastening rubber 94 is fixed to the lower panel 92 via the clip 20.

Moreover, at the clip 20, the hook portion 30 catches on the upper end portion 92A of the lower panel 92 from the same direction as the direction (the arrow D direction) in which the protruding portion 96 of the fastening rubber 94 catches on the caught-on portion 26. Therefore, in a case in which force in the arrow D direction (in the present embodiment, the restoring force F) is applied to the fastening rubber 94, it is difficult for the hook portion 30 to come-off of the upper end portion 92A of the lower panel 92 for the restoring force F that is received from the protruding portion 96 via the caught-on portion 26.

Further, at the clip 20, the shape of the hook portion 30 is made to be a shape that covers the upper end portion 92A of the lower panel 92 from the obverse side to the reverse side. Therefore, it is easy for the hook portion 30 to be caught on the upper end portion 92A of the lower panel 92. In addition, at the clip 20, it is difficult for the hook portion 30 to come-off of the upper end portion 92A of the lower panel 92 for the restoring force F.

Further, at the clip 20, the claw portion 32 is, in a state of being elastically deformed, inserted into the insert hole 93 together with the insert portion 28, and, when the claw portion 32 that has been inserted is restored, the claw portion 32 is caught on the edge portion of the insert hole 93. Therefore, the insert portion 28 coming-out from the insert hole 93 is suppressed. Thus, it is more difficult for the clip 20 to come-off of the lower panel 92. In particular, at the clip 20, when the claw portion 32 that has been inserted is restored, the claw portion 32 is caught on the edge portion that is at the seat upper side (the side opposite the arrow D direction) of the insert hole 93. Therefore, at this clip 20, floating-up, from the lower panel 92, of the clip main body 22 around the hook portion 30 or the insert portion 28 as fulcrum is suppressed as compared with a structure in which, for example, the claw portion 32 is made to be elastically deformable toward the clip length direction one side (the side opposite the arrow D direction).

At the clip 20, because the insert portion 28 is disposed further toward the clip length direction another side (the arrow D direction side) than the hook portion 30, it is easy for the hook portion 30 to be caught on the upper end portion 92A of the lower panel 92, as compared with a case in which, for example, the insert portion 28 is disposed further toward the clip length direction one side (the side opposite the arrow D direction) than the hook portion 30.

Further, at the clip 20, in the state in which the protruding portion 96 is caught on the opening edge portion at the clip length direction one side (the side opposite the arrow D direction) of the cut-out portion 36, movement of the protruding portion 96 in the direction orthogonal to the arrow D direction is restricted by the wall portions 38. Therefore, at the clip 20, the protruding portion 96 coming-off of the caught-on portion 26 is suppressed, as compared with a structure that does not have the wall portions 38 for example. Namely, it is difficult for the fastening rubber 94 to come-out of the clip 20.

### Second Exemplary Embodiment

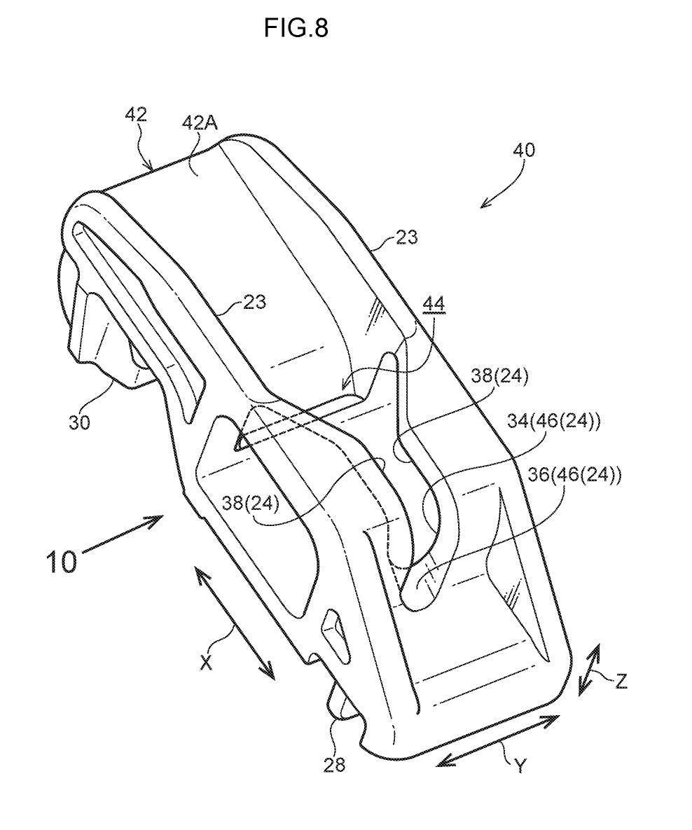

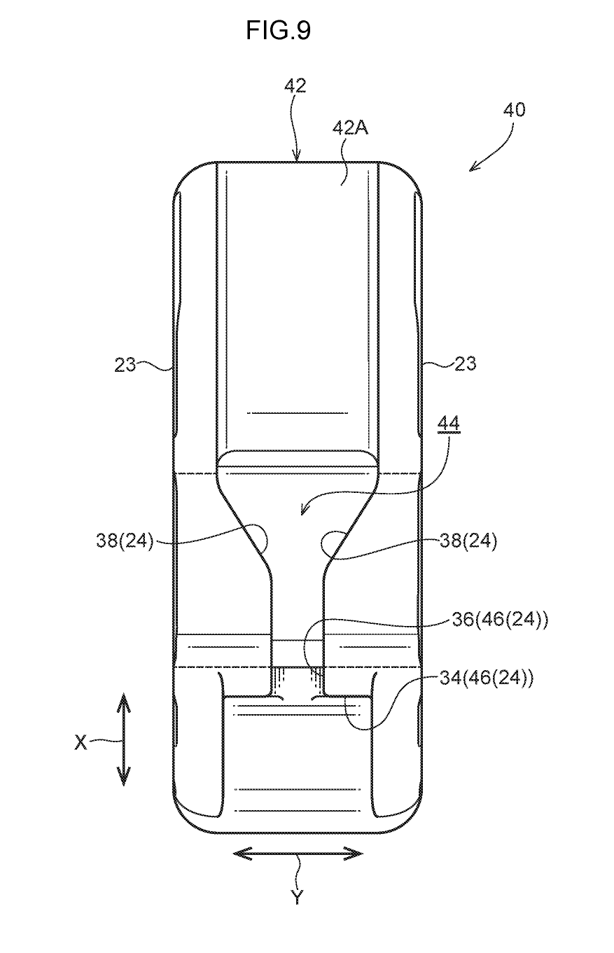

A clip 40 relating to a second exemplary embodiment of the present invention is described next on the basis of FIG. 8 through FIG. 10. In the same way as the clip 20 of the first exemplary embodiment, the clip 40 of the present embodiment also is used for fixing the fastening rubber 94, that is for attaching the seatback cover 90 to the seatback main body 86 of the seat 80, to the lower panel 92 of the seatback main body 86. Note that structures that are similar to those of the first embodiment are denoted by the same reference numerals, and description thereof is omitted as appropriate.

As shown in FIG. 8 through FIG. 10, at the clip 40 of the present embodiment, other than the structures of a clip main body 42 and a caught-on portion 46, the other structures are structures that are similar to those of the clip 20 of the first embodiment.

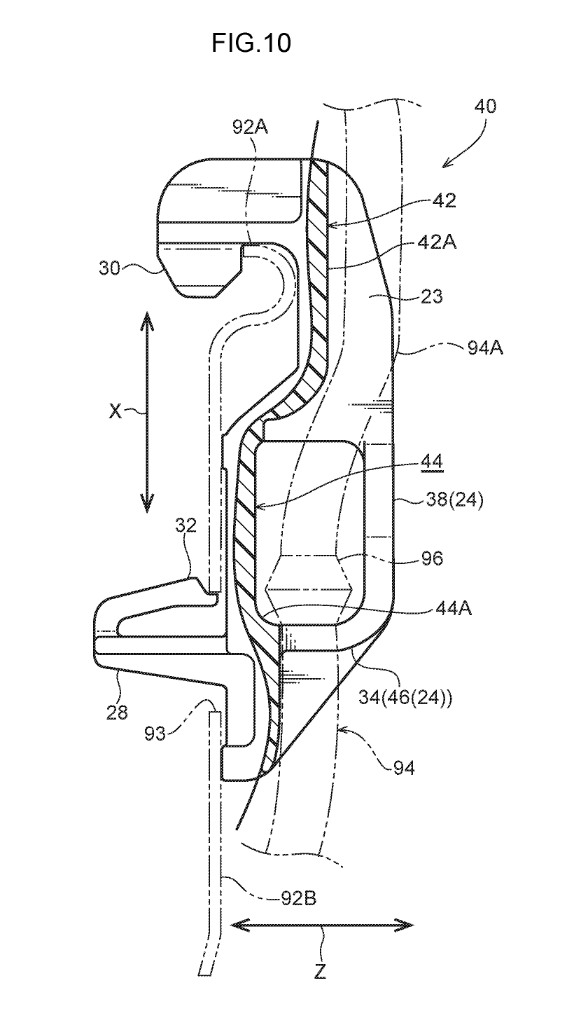

As shown in FIG. 10, a concave portion 44 is formed in an obverse 42A of the clip main body 42, between the insert portion 28 and the hook portion 30 in the clip length direction. The plate-shaped portion 34 is disposed at a portion that corresponds to a concave wall 44A that is at the clip length direction another side of the concave portion 44. A portion of the protruding portion 96 of the fastening rubber 94 is accommodated in the concave portion 44 in the state in which the protruding portion 96 is caught on the caught-on portion 46. Note that, in the present embodiment, because the protruding portion 96 is caught on the concave wall 44A as well, the concave wall 44A also is included in the caught-on portion 46.

Note that the attachment processes for attaching the seatback cover 90 to the seatback main body 86 by using the clip 40 of the present embodiment are similar to those of the first embodiment.

Operation and effects of the clip 40 of the present embodiment are described next.

Note that description of operation and effects, that are obtained by structures that are similar to those of the clip 20 relating to the first exemplary embodiment, is omitted.

At the clip 40 of the present embodiment, the concave portion 44 is formed in the obverse 42A of the clip main body 42 such that a portion of the protruding portion 96 of the fastening rubber 94 is accommodated therein. Therefore, the height of the side wall portions 23 can be made to be low as compared with the clip 20 of the first exemplary embodiment. Due thereto, the thickness of the clip 40 is made thin, and compactness of the clip 40 can be devised.

### Third Exemplary Embodiment

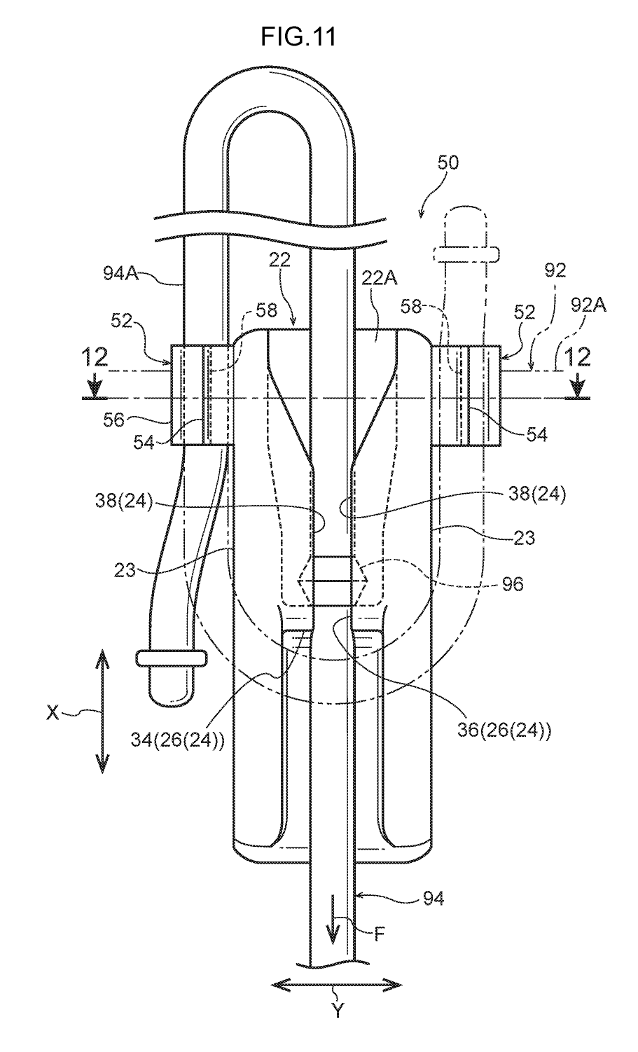

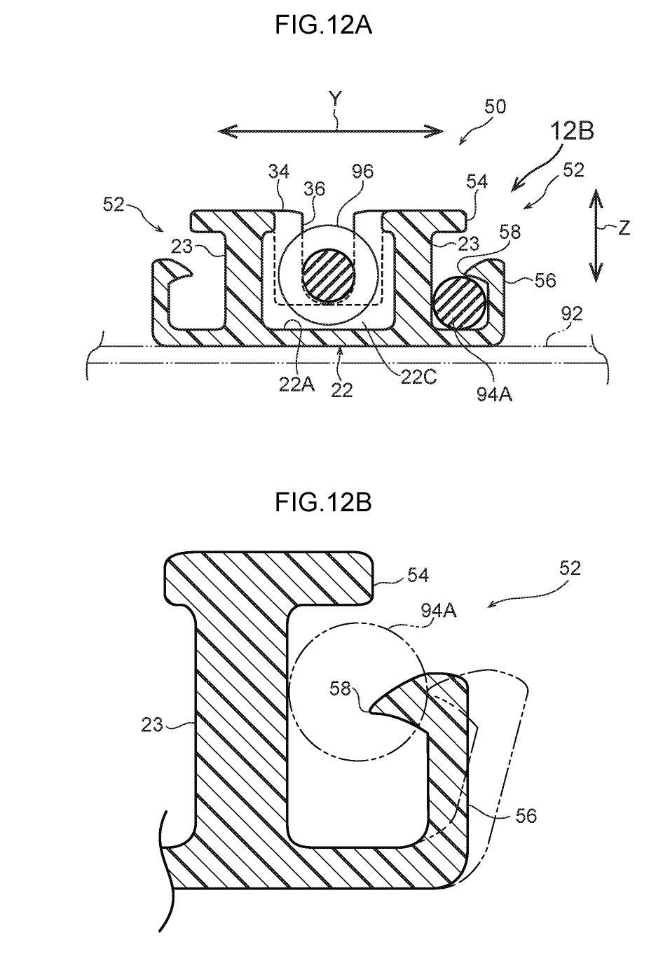

A clip 50 relating to a third exemplary embodiment of the present invention is described next on the basis of FIG. 11 and FIGS. 12A and 12B. In the same way as the clip 20 of the first exemplary embodiment, the clip 50 of the present embodiment also is used for fixing the fastening rubber 94, that is for attaching the seatback cover 90 to the seatback main body 86 of the seat 80, to the lower panel 92 of the seatback main body 86. Note that structures that are similar to those of the first exemplary embodiment are denoted by the same reference numerals, and description thereof is omitted as appropriate.

As shown in FIG. 11 and FIGS. 12A and 12B, at the clip 50 of the present embodiment, surplus length holding portions 52 for holding the surplus length portion 94A of the fastening rubber 94 are provided at the side wall portions 23 of the clip main body 22. Other than the structure of providing the surplus length holding portions 52, the other structures of the clip 50 are structures that are similar to those of the clip 20 of the first exemplary embodiment.

Note that the attachment processes for attaching the seatback cover 90 to the seatback main body 86 by using the clip 50 of the present embodiment are similar to those of the first exemplary embodiment.

As shown in FIG. 11, the surplus length holding portions 52 are provided at the outer surfaces of the side wall portions 23 of the clip 50. As shown in FIG. 12A, the surplus length holding portion 52 has a protruding portion 54, that protrudes-out from a clip thickness direction one side end portion of the side wall portion 23 toward the clip transverse direction outer side, having a substantially L-shaped plate shape, and an accommodating portion 56 that is plate-shaped and is elastically deformable and that protrudes-out from the clip thickness direction another side end portion of the side wall portion 23 toward the clip transverse direction outer side, and that, in the midst of protruding-out, is bent toward the clip thickness direction one side. A claw portion 58, that projects-out toward the outer surface of the side wall portion 23, is formed at the distal end portion of the accommodating portion 56. At the time of accommodating the fastening rubber 94 at the inner side of the accommodating portion 56, as shown in FIG. 12B, the accommodating portion 56 is elastically deformed such that the gap between the protruding portion 54 and the claw portion 58 is opened, and, in this state, the surplus length portion 94A of the fastening rubber 94 is accommodated at the inner side of the accommodating portion 56.

Further, in the present embodiment, as shown in FIG. 11, the surplus length holding portions 52 are provided respectively at the side wall portions 23 at the both sides of the clip 50.

Operation and effects of the clip 50 of the present embodiment are described next. Note that description of operation and effects, that are obtained by structures that are similar to those of the clip 20 relating to the first exemplary embodiment, is omitted.

At the clip 50 of the present embodiment, the surplus length holding portions 52 are provided at the side wall portions 23. Therefore, by causing the surplus length portion 94A of the fastening rubber 94 to be held by the surplus length holding portion 52, the protruding portion 96 coming-out of the holding portion 24 due to the surplus length portion 94A being pulled upward can be suppressed. In particular, at the clip 50, because the surplus length holding portions 52 are provided at the side wall portions 23 at the both sides respectively, even if the surplus length portion 94A of the fastening rubber 94 is long, the protruding portion 96 coming-out of the holding portion 24 can be suppressed due to the surplus length portion 94A being held so as to be trained around the surplus length holding portions 52 at the both sides.

The structure of providing the surplus length holding portions 52 at the side wall portions 23 of the clip 50 of the third exemplary embodiment may be applied to the clip 40 of the second exemplary embodiment.

Further, at the clip 50 of the third exemplary embodiment, there is a structure in which the surplus length holding portions 52 are provided at the side wall portions 23 at the both sides, respectively. However, the present invention is not limited to this structure, and may be a structure in which the surplus length holding portion 52 is provided at only one of the side wall portions 23.

Further, at the clip 50 of the third exemplary embodiment, the protruding portion 54 is formed at the clip thickness direction one side of the side wall portion 23, and the accommodating portion 56 is formed at the clip thickness direction another side. However, the present invention is not limited to this structure, and may be a structure in which the accommodating portion 56 is formed at the clip thickness direction one side, and the protruding portion 54 is formed at the clip thickness direction another side. In this case, it is more difficult for the surplus length portion 94A of the fastening rubber 94 to come-out from the surplus length holding portion 52.

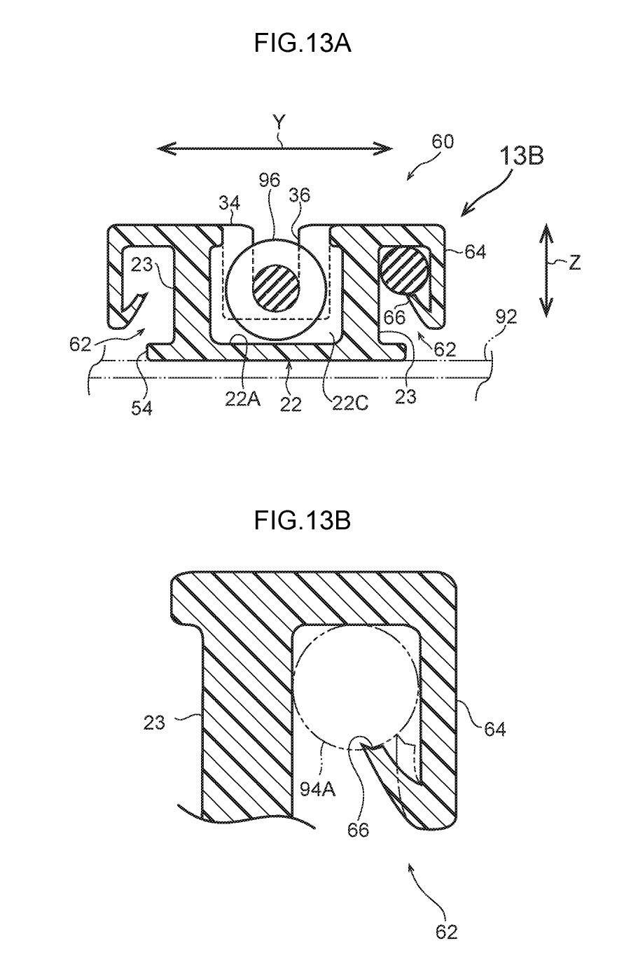

Further, at the clip 50 of the third exemplary embodiment, the accommodating portion 56 is made to be an elastically deformable structure, but the present invention is not limited to this structure. For example, as with a clip 60 that is a modified example of the clip 50 and is shown in FIG. 13A, there may be a structure in which a claw portion 66 elastically deforms as shown in FIG. 13B, with an accommodating portion 64 that structures a surplus length holding portion 62 being not elastically deforming.

### Other Embodiments

In the first exemplary embodiment, there is a structure in which the hook portion 30 of the clip 20 is caught on the upper end portion 92A of the lower panel 92, but the present invention is not limited to this structure. There may be a structure in which, in a case in which the fastening rubber 94 that is mounted to the seatback cover 90 is circled around the seat upper side of the seatback main body 86 and is pulled-out to the back surface portion of the seatback main body 86, the hook portion 30 of the clip 20 is caught on the lower end portion of the lower panel 92, and the protruding portion 96 is held by the holding portion 24. In this case, the direction in which the protruding portion 96 is caught on the caught-on portion 26 is the seat upward direction, and the restoring force F is applied in the seat upward direction. Note that the above-described structure may be applied to the second exemplary embodiment and the third exemplary embodiment.

Further, in the first exemplary embodiment, there is a structure in which the hook portion 30 of the clip 20 is caught on the upper end portion 92A of the lower panel 92, but the present invention is not limited to this structure. For example, there may be a structure in which an opening portion is formed between the insert hole 93 and the upper end portion 92A of the lower panel 92, and the hook portion 30 of the clip 20 is caught on an edge portion (an example of the caught-on portion in the present invention) of this opening portion. Further, there may be a structure in which a portion (an example of the caught-on portion in the present invention) that is exclusively used for the hook portion 30 to be caught on is provided at the lower panel 92, and the hook portion 30 is caught on this exclusive-use portion. Note that the above-described structure may be applied to the second exemplary embodiment and the third exemplary embodiment.

Moreover, in the first exemplary embodiment, the clip 20 is used in the attaching of the seatback cover 90 and the seatback main body 86 of the vehicle seat 80, but the present invention is not limited to this structure. Provided that the object of application is a seat that is of a structure similar to that of the vehicle seat 80 (e.g., a seat of a ship or of an airplane), the clip 20 may be used in the attaching of a seatback cover and a seatback main body of such a seat. Note that the above-described structure may be applied to the second exemplary embodiment and the third exemplary embodiment.

In the first exemplary embodiment, the fastening rubber 94 is used as an example of the linear member, but the present invention is not limited to this structure. An elastic body (a resin or an elastomer or the like) that is stretchable and that is other than rubber may be used as an example of the linear member.

Further, natural fibers, synthetic fibers, metal and the like may be used as examples of the linear member. In such a case, force in the arrow D direction is applied to the linear member due to the restoring force of the cushion material 88 that is fastened at the time when the seatback cover 90 is attached to the seatback main body 86, or due to the pressure that is applied to the cushion material 88 at the time when a person sits in the seat 80. Note that the above-described structure may be applied to the second exemplary embodiment and the third exemplary embodiment.

In the first exemplary embodiment, there is a structure in which the claw portion 32 is provided at the insert portion 28, but the present invention is not limited to this structure, and may be a structure in which the claw portion 32 is not provided at the insert portion 28. Note that the structure in which the claw portion 32 is not provided at the insert portion 28 may be applied to the second exemplary embodiment and the third exemplary embodiment.

Further, in the first exemplary embodiment, there is a structure in which the claw portion 32 that is elastically deformable toward the arrow D direction side is provided at the outer periphery of the insert portion 28, but the present invention is not limited to this structure. The claw portion 32 that is elastically deformable toward the side opposite the arrow D direction may be provided at the outer periphery of the insert portion 28, or the claw portion 32 that is elastically deformable in a direction other than these directions may be provided.

Although the present invention has been described above by using exemplary embodiments as examples, these exemplary embodiments are merely examples, and the present invention can be implemented by being modified in various ways within a scope that does not depart from the gist thereof. Further, the scope of the present invention, of course, is not limited to these exemplary embodiments.

What is claimed is:

1. A clip comprising:
a clip main body;
a holding portion that is provided at the clip main body, and that has a caught-on portion on which a protruding portion, that protrudes-out from an outer periphery of a linear member, is caught, and that holds the protruding portion that is caught on the caught-on portion;
an insert portion that is provided at the clip main body, and that is inserted into an insert hole formed in a mounted-to member; and
an anchor portion that is provided at the clip main body, and that is caught on an anchored-on portion, formed at the mounted-to member, in a same direction as a catch direction in which the protruding portion is caught on the caught-on portion.

2. The clip of claim 1, wherein:
the mounted-to member is a panel member,
the anchored-on portion is an end portion of the panel member, and
the anchor portion is a hook portion having a shape that covers the end portion of the panel member from an obverse side to a reverse side.

3. The clip of claim 2, further comprising a claw portion that is elastically deformable, and that projects-out from an outer periphery of the insert portion, the claw portion being inserted in the insert hole together with the insert portion in an elastically deformed state, and being caught on an edge portion of the insert hole by being restored from the deformed state.

4. The clip of claim 3, wherein the insert portion is disposed further toward a side of the catch direction than the hook portion.

5. The clip of claim 4, wherein the claw portion is elastically deformable toward the side of the catch direction.

6. The clip of claim 1, wherein:
the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and
the holding portion has a wall portion that is provided at the plate-shaped portion and restricts movement, in a direction orthogonal to the catching direction, of the protruding portion that is caught on the opening edge portion of the cut-out portion.

7. The clip of claim 2, wherein:
the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and
the holding portion has a wall portion that is provided at the plate-shaped portion and restricts movement, in a direction orthogonal to the catching direction, of the protruding portion that is caught on the opening edge portion of the cut-out portion.

8. The clip of claim 3, wherein:
the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and
the holding portion has a wall portion that is provided at the plate-shaped portion and restricts movement, in a direction orthogonal to the catching direction, of the protruding portion that is caught on the opening edge portion of the cut-out portion.

9. The clip of claim 4, wherein:
the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and
the holding portion has a wall portion that is provided at the plate-shaped portion and restricts movement, in a direction orthogonal to the catching direction, of the protruding portion that is caught on the opening edge portion of the cut-out portion.

10. The clip of claim 5, wherein:
the caught-on portion is configured to include a plate-shaped portion, and a cut-out portion that is formed in the plate-shaped portion, through which the linear member is inserted and at which the protruding portion is caught on an opening edge portion of the cut-out portion at a side opposite the catching direction side, and
the holding portion has a wall portion that is provided at the plate-shaped portion and restricts movement, in a direction orthogonal to the catching direction, of the protruding portion that is caught on the opening edge portion of the cut-out portion.

11. The clip of claim 1 further comprising a concave portion that is formed in the clip main body such that a part of the protruding portion is accommodated in the concave portion in a state in which the protruding portion is caught on the caught-on portion.

12. The clip of claim 10 further comprising a concave portion that is formed in the clip main body such that a part of the protruding portion is accommodated in the concave portion in a state in which the protruding portion is caught on the caught-on portion.

13. The clip of claim 1 further comprising a linear member holding portion that is formed at an outer side portion of the holding portion, and that holds the linear member.

14. The clip of claim 10 further comprising a linear member holding portion that is formed at an outer side portion of the holding portion, and that holds the linear member.
